(19) United States
(12) Patent Application Publication
(10) Pub. No.: US 2011/0156310 A1
(43) Pub. Date: Jun. 30, 2011

(54) SHAPE MEMORY POLYMER

(75) Inventors: Joseph D. Rule, Cottage Grove, MN (US); Kevin M. Lewandowski, Inver Grove Heights, MN (US)

(73) Assignee: 3M Innovative Properties Company

(21) Appl. No.: 13/036,059

(22) Filed: Feb. 28, 2011

Related U.S. Application Data
(62) Division of application No. 12/608,313, filed on Oct. 29, 2009.
Application No. 12/608,313 is a continuation-in-part of application No. 12/339,502, filed on Dec. 19, 2008, now abandoned.

(51) Int. Cl. B29C 35/02; C08F 32/04; C08L 45/00; C08F 4/80; C08F 277/00

(52) U.S. Cl. 264/319; 526/348.2; 524/855; 526/171; 525/289; 525/290

(57) ABSTRACT

A shape memory polymer composition is described comprising greater that 90 wt. % cyclooctene, less than 10 wt. % of a multicyclic diene, comprising at least two cyclo olefinic rings with at least two reactive double bonds, and less than 2 wt. % of a metathesis catalyst.

### CROSS REFERENCE TO RELATED APPLICATIONS

This application is a divisional of U.S. application Ser. No. 12/608,313, filed Oct. 29, 2009, now pending; which is a continuation-in-part of U.S. application Ser. No. 12/339,502, filed Dec. 19, 2008, now abandoned, the disclosure of which is incorporated by reference in their entirety herein.

### FIELD OF THE INVENTION

This disclosure relates to a shape memory polymer composition, polymers therefrom, and articles prepared from the shape memory composition.

### BACKGROUND

Shape memory polymers (SMPs) have the unique ability to “remember” a pre-set shape and, upon exposure to the appropriate stimuli, shift from a deformed or altered shape back to the pre-set shape. Several commercially important uses have been developed for shape memory polymers. For example, shape memory polymers are commonly used in various medical, dental, mechanical, and other technology areas for a wide variety of products.

SMP's have a defined melting point (Tₘ) or glass transition temperature (T_{g}). Above the Tₘ or T_{g}, the polymers are elastomeric in nature, and are capable of being deformed with high strain. The elastomeric behavior of the polymers results from either chemical crosslinks or physical crosslinks (often resulting from microphase separation). Therefore, SMP's can be glassy or crystalline and can be either thermosets or thermoplastics.

The permanent shape of the SMP is established when the crosslinks are formed in an initial casting or molding process. The SMP can be deformed from the original shape to a temporary shape. This step is often done by heating the polymer above its Tₘ or T_{g} and deforming the sample, and then holding the deformation in place while the SMP cools. Alternatively, in some instances the polymer can be deformed at a temperature below its Tₘ or T_{g} and maintain that temporary shape. Subsequently, the original shape is recovered by heating the material above the melting point or glass transition temperature. The recovery of the original shape, which is induced by an increase in temperature, is called the thermal shape memory effect. Properties that describe the shape memory capabilities of a material are the shape recovery of the original shape and the shape fixity of the temporary shape.

Shape memory polymers may be considered super-elastic rubbers; when the polymer is heated to a rubbery state, it can be deformed under resistance of about 1 MPa modulus, and when the temperature is decreased below either a crystallization temperature or a glass transition temperature, the deformed shape is fixed by the lower temperature rigidity while, at the same time, the mechanical energy expended on the material during deformation is stored. When the temperature is raised above the transition temperature (Tₘ or T_{g}), the polymer will recover to its original form as driven by the restoration of network chain conformational entropy. The advantages of the SMPs will be closely linked to their network architecture and to the sharpness of the transition separating the rigid and rubber states. SMPs have an advantage of high strain: to several hundred percent.

### SUMMARY

The present disclosure provides a shape memory polymer composition comprising greater that 90 wt. % cyclooctene, less than 10 wt. % of a multicyclic diene, comprising at least two cyclo olefinic rings with at least two reactive double bonds, and less than 2 wt. % of a metathesis catalyst. In another aspect, the disclosure provides a shape memory polymer comprising greater that 90 wt. % polymerized cyclooctene, and crosslinked with less than 10 wt. % of a multicyclic olefin with at least two cyclo olefinic rings with at least two reactive double bonds. In another aspect, the present disclosure provides elastically deformed shaped articles, which when heated above a transition temperature, will elastically recover to an original form. Alternatively, the recovery of a deformed shaped article may be effected by application of a low molecular weight organic compound, such as a solvent, to act as a plasticizer.

In another embodiment, the disclosure provides a method of preparing a shaped article comprising the steps of casting the shape memory polymer composition into a mold and allowing it to cure. The resultant permanent shape of the shaped article is the result of the crosslinking of the cured polymer.

The instant shape memory polymers provides tunable elastic rubbery modulus above the Tₘ and elastic semicrystalline modulus below the Tₘ. Besides their shape memory effects, these materials are also castable; allowing for the preparation and processing of more complex shaped articles.

The shape polymer composition may be used in the preparation of any shaped article in which it is advantageous for the article to elastically recover an original shape when heated above a Tₘ. In some embodiments the shape memory polymer composition may be cast into a permanent shape and deformed to a temporary shape at a temperature below the Tₘ so the deformed temporary shape is retained. Alternatively, the shape memory polymer composition may be cast into a permanent shape, deformed at a temperature above the Tₘ, and then cooled to a temperature below the Tₘ so the deformed temporary shape is retained. With either deformation method, when the deformed article is heated above the Tₘ, or by exposure to solvent, the deformed article will elastically recover the permanent shape.

Useful shaped articles include mechanical fasters, orthodontic appliances, stents, patches and other implants for human health care, arbitrarily shape-adjustable structural implements, including personal care items (dinnerware, brushes, etc.) and hardware tool handles, self healing plastics, drug delivery, rheological modifiers for paints, detergents and personal care products, impression material for molding, duplication, rapid prototyping, orthodontics, and figure-printing, toys, reversible embossing for information storage, temperature sensors, safety valve, heat shrink tapes or seals, and heat controlled couplings.

### BRIEF DESCRIPTION OF THE DRAWINGS

FIGS. 1 and 2 show a shape-memory cycle with Example 3.

### DETAILED DESCRIPTION

In addition to cyclooctene, the shape memory polymer composition comprises one or more multicyclic diene comprising at least two cyclo olefinic rings with at least two reactive double bonds. This class of shape-memory polymers depends on the crystalline domains and/or plastic deformation of polycyclooctene to hold a temporary deformed shape, and the polycylooctene must be chemically crosslinked to hold a permanent shape. The multicyclic diene crosslinking agent comprises at least two cyclo olefinic rings with at least two reactive double bonds. The rings may be fused or non-fused, spiro or bridging rings, and may be part of a larger ring system. As used herein, double bonds of the cyclo olefinic rings are considered reactive if they can undergo ring-opening metathesis polymerization under typical reaction conditions as described herein.

Exemplary multicyclic dienes may be selected from the group consisting of dicyclopentadiene, tricyclopentadiene, tetracyclopentadiene, norbornadiene, tetracyclo[6,2,13,6,0^{2,7}]dodeca-4,9-diene, and alkyl derivatives thereof. Other examples of multifunctional polycyclic monomers include:

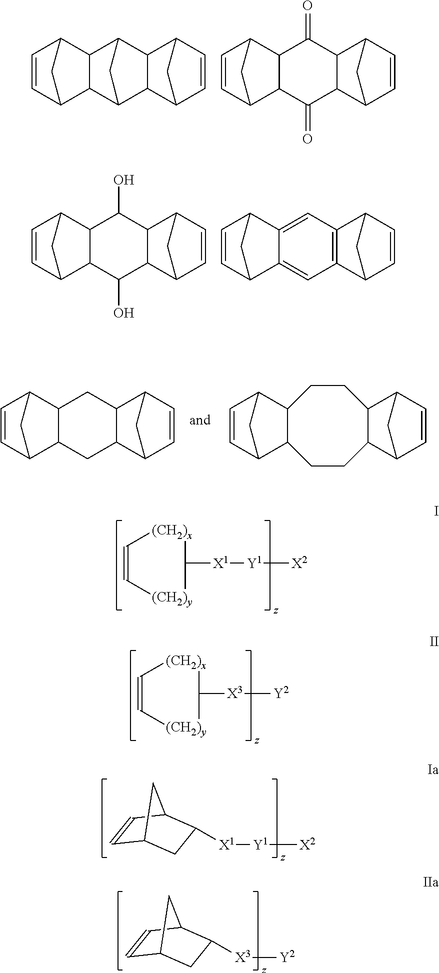

With respect to Formula I, X¹ is a divalent aliphatic or aromatic group with 0 to 20 carbon atoms; X² is a divalent aliphatic or aromatic group with 0 to 20 carbon atoms; optional group Y¹ is a divalent functional group selected from the group consisting of esters, amides, ethers, urethanes and silanes; and z is at least 2, preferably 2. With respect to Formula II, X³ is —O—, —S— or —NR¹—, where R¹ is H or C₁-C₄ alkyl, Y² is a divalent aliphatic or aromatic group with 0 to 20 carbon atoms, optionally containing Y¹, z is at least 2, preferably 2, x is at least one, y may be zero, and x+y is 1 to 20, preferably 1 to 5. It will be further understood that the depicted rings system may be part of a larger ring system. For example, in Formulas Ia and IIa, the indicated norbornyl ring may be considered as within the scope of the ring systems of Formula I and II.

Examples of that fall within Formula I and Ia include:

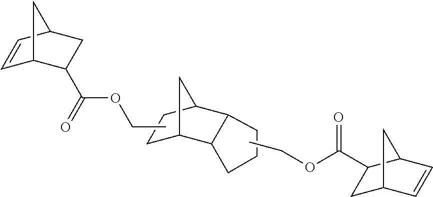

In general, the shape memory polymers disclosed herein comprise one or more polymers prepared by ring opening metathesis polymerization of cyclooctene and one or more multicyclic dienes catalyzed by olefin metathesis catalysts; see for example, K. J. Ivin, “Metathesis Polymerization” in J. I. Kroschwitz, ed., Encyclopedia of Polymer Science and Engineering, Vol. 9, John Wiley & Sons, Inc., U.S.A., 1987, p. 634. Metathesis polymerization of cycloalkene monomers typically yields polymers having an unsaturated linear backbone. The degree of unsaturation of the repeat backbone unit of the polymer is the same as that of the monomer. For example, with cyclooctene and dicyclopentadiene reactants in the presence of an appropriate catalyst, the resulting polymer may be represented by:

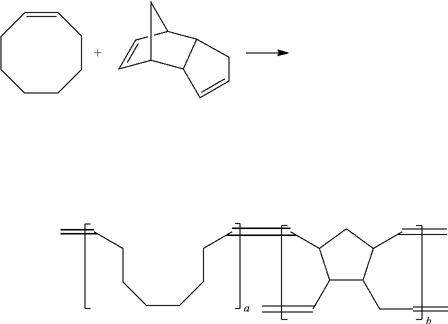

wherein a+b is the number of moles of polymerized monomers, and b/(a+b) is the mole fraction of monomer units which ring-open at both reactive sites. As shown by the above reaction, metathesis polymerization of cyclooctene and a multicyclic diene can result in a crosslinked polymer. The degree of unsaturation of the repeat backbone unit of the polymer is the same as that of the monomers. With respect to the above scheme, it will be understood that the resulting polymer may further contain monomer units resulting from the metathesis of just one of the reactive double bonds of dicyclopentadiene; i.e. the resulting polymer may contain:

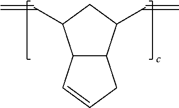

where c has a non-zero value and a+(b+c) is the number of moles of polymerized monomers. Because the second double bonds of some multicyclic dienes, such as dicyclopentadiene or norbornadiene, are less reactive in a metathesis reaction, different amounts are generally required to produce sufficient amounts of crosslinking. Also, some multicyclic dienes, such as dicyclopentadiene disrupt crystallinity of the cyclooctene more than others, and must therefore be used at lower levels to maintain a sufficient modulus below the Tₘ; i.e. less than 3 wt. %.

The multicyclic diene may crosslink the cyclooctene polymer as described above. The degree to which crosslinking occurs depends on the relative amounts of different monomers and on the conversion of the reactive groups in those monomers, which in turn, is affected by reaction conditions including time, temperature, catalyst choice, and monomer purity. The multicyclic diene is used in amount such that the polymer is crosslinked, and the difference in elastic modulus of the polymer between 0° C. and 80° C. is maximized. Preferably, the elastic modulus of the polymer at 0° C. is at least 0.5 MPa and the elastic modulus at 80° C. is at least 90 MPa. Generally the multicyclic diene is used in amounts of 0.1 to less than 10 wt. % of the polymer composition, preferably less than 5%, more preferably less than 3 wt. %.

The degree of crosslinking affects the modulus of the shape memory polymer above the Tₘ. If the crosslinking density is too high, the polymer breaks at relatively low levels of elongation. With no crosslinking, the polymer yields at high temperature and does not display shape-memory.

The shape memory polymer composition additionally comprises a metathesis catalyst, see for example, K. J. Ivin, “Metathesis Polymerization” in J. I. Kroschwitz, ed., Encyclopedia of Polymer Science and Engineering, Vol. 9, John Wiley & Sons, Inc., U.S.A., 1987, p. 634. Transition metal carbene catalysts such as ruthenium, osmium, and rhenium catalysts may be used, including versions of Grubbs catalysts and Grubbs-Hoveyda catalysts; see, for example, U.S. Pat. No. 5,849,851 (Grubbs et al.).

In some embodiments, the monomer composition comprises a metathesis catalyst system comprising a compound of the formula:

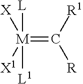

wherein:

M is selected from the group consisting of Os and Ru;

R and R¹ are independently selected from the group consisting of hydrogen and a substituent group selected from the group consisting of C₁-C₂₀ alkyl, C₂-C₂₀ alkenyl, C₂-C₂₀ alkoxycarbonyl, aryl, C₁-C₂₀ carboxylate, C₁-C₂₀ alkoxy, C₂-C₂₀ alkenyloxy, C₂-C₂₀ alkynyloxy and aryloxy; the substituent group optionally substituted with a moiety selected from the group consisting of C₁-C₅ alkyl, halogen, C₁-C₅ alkoxy and phenyl; the phenyl optionally substituted with a moiety selected from the group consisting of halogen, C₁-C₅ alkyl, and C₁-C₅ alkoxy;

X and X¹ are independently selected from any anionic ligand; and

L and L¹ are independently selected from any phosphine of the formula —PR³R⁴R⁵, wherein R³ is selected from the group consisting of neophyl, secondary alkyl and cycloalkyl and wherein R⁴ and R⁵ are independently selected from the group consisting of aryl, neophyl, C₁-C₁₀ primary alkyl, secondary alkyl, and cycloalkyl. L and L1 are also independently selected from imidazol-2-ylidine, and dihydroimidazol-2-ylidine groups.

The metathesis catalyst system may also comprise a transition metal catalyst and an organoaluminum activator. The transition metal catalyst may comprise tungsten or molybdenum, including their halides, oxyhalides, and oxides, such as WCl₆. The organoaluminum activator may comprise trialkylaluminums, dialkylaluminumhalides, or alkylaluminumdihalides. Organotin and organolead compounds may also be used as activators, for example, tetraalkyltins and alkyltinhydrides may be used.

The choice of particular catalyst system and the amounts used may depend on the particular amounts of monomers being used, as well as on desired reaction conditions, desired rate of cure, and so forth. In particular, it is be desirable to include the above-described osmium and ruthenium catalysts in amounts of from about 0.001 to about 2.0 wt. %, preferably about 0.01 to 0.5 wt. %, relative to the total weight of the cyclooctene and multicyclic diene.

Both the WCl₆ catalyst precursor and the (C₂H₅)₂AlCl activator are sensitive to ambient moisture and oxygen, so it is preferable to maintain the reactive solutions under inert conditions. Once mixed, the catalyst solution may be injected into an air-filled mold as long the polymerization is rapid and exposure to air is minimized. Preferably, the mold can be purged with an inert gas such as nitrogen before introducing the monomer composition. The polymerization can occur at room temperature, or heat can be used to help accelerate the polymerization.

The monomer composition may comprise additional optional components. For example, if the metathesis catalyst system comprises WCl₆/(C₂H₅)₂AlCl, then water, alcohols, oxygen, or any oxygen-containing compounds may be added to increase the activity of the catalyst system as described in Ivin. Other additives can include chelators, Lewis bases, plasticizers, inorganic fillers, and antioxidants, preferably phenolic antioxidants.

In the catalyst solution, the WCl₆ catalyst precursor may cause the polymerization of the monomer before being mixed with the organoaluminum or organotin activator solution. To prevent this premature polymerization, a chelator or Lewis base stabilizer can be added to the WCl₆ solution as taught in U.S. Pat. No. 4,400,340 (Klosiewicz et al). Particularly preferred stabilizers are 2,4-pentanedione or benzonitrile. This can be added at 50 mol % to 300 mol % and more preferably from 100 mol % to 200 mol % relative to the WCl₆.

It is also taught in U.S. Pat. No. 4,400,340 (Klosiewicz et al) that the addition of a Lewis base to the activator solution can slow the gelation of the mixed monomer composition, thus allowing increased working time. One preferred Lewis base for this purpose is butyl ether. Another preferred Lewis base moderator which is beneficial in that it can be polymerized into the shape memory polymer is norborn-2-ene-5-carboxylic acid butyl ester. The Lewis base moderator can be included from about 0 mol % to 500 mol %, and more preferably from 100 mol % to 300 mol % relative to the organoaluminum or organotin activator.

Additionally, a halogen-containing additive can be included to increase conversion of monomer during the polymerization, as taught in U.S. Pat. No. 4,481,344 (Newburg et al). This halogen-containing compound can be included from 0 mol % to 5000 mol %, and preferably from 500 mol % to 2000 mol. % all relative to the WCl₆. A particularly preferable halogen containing additive is ethyl trichloroacetate.

To produce a shaped article from the shape memory polymer composition, it is desirable that no solvent be included in the formulations. If solvent is used to help initially dissolve some component of the catalyst system, such as the WCl₆, it is desirable to remove the solvent under vacuum before polymerizing the mixture.

Preferably, the catalyst is selected from benzylidenbis(tricyclohexylphosphin) dichlororuthenium (Grubbs I catalyst) or Benzyliden[1,3-bis(2,4,6-trimethylphenyl)-2-imidazolidinyliden]dichloro(tricyclohexylphosphin)ruthenium (Grubbs II catalysts). Reference may be made to U.S. Pat. Nos. 5,831,108 and 6,111,121 (Grubbs et al.). Solvent is not normally removed from the Grubbs I and II catalysts, due to their rapid reactivity in the presence of the monomers.

Other additives can include plasticizers, organic or inorganic fillers, and antioxidants, preferably phenolic antioxidants. Any such additional additives should be used in amounts such that the crystallinity of the shape memory polymer is maintained. Generally such additives are used in amounts of less that 5 wt. %, relative to the total amount of the shape memory polymer composition.

The double blind fasteners can be prepared from the shape memory polymer compositions by any suitable technique used for thermoset polymers. The double blind fasteners may be cast into a suitable mold and cured, or injection molded, such as by reaction injection molding (RIM) whereby the polymer composition is injected into a mold and cured. Alternately, double blind fasteners prepared from thermoplastic SMPs may be prepared by injection molding, blowing and extrusion.

The mold may be flexible or rigid. Useful materials that may be used to make the mold include metal, steel, ceramic, polymeric materials (including thermoset and thermoplastic polymeric materials), or combinations thereof. The materials forming the mold should have sufficient integrity and durability to withstand the particular monomer compositions to be used as well as any heat that may be applied thereto or generated by the polymerization reaction. In some embodiments, the mold may comprise an injection mold. In this case, the mold may comprise two halves which mate together. For injection molding, the monomer composition may be injected via an injection port into a cavity or cavities of the mold, and there is typically some output port for air, nitrogen, etc. to escape. Filling of the cavity may be facilitated by vacuum attached via the output port.

To prepare a double blind fasteners having a shape memory, the article can be molded and crosslinked to form a permanent shape. If the article subsequently is formed into a second shape by deformation, the object can be returned to its original shape by heating the object above the Tₘ. In other embodiments, a solvent such as alkyl alcohol, acetone, etc. can partially dissolve or plasticize the crystalline phase and cause the same recovery.

The original shaped article, having a first permanent shape, may then be deformed by either of two methods. In the first, the shaped article, as molded, is heated above the Tₘ or T_{g}, deformed to impart a temporary shape, then cooled below the Tₘ or T_{g} to lock in the temporary shape. In the second, the shaped article is deformed at a temperature below the Tₘ or T_{g} by the application of mechanical force, whereby the shaped article assumes a second temporary shape through forced deformation; i.e. cold drawing. When significant stress is applied, resulting in an enforced mechanical deformation at a temperature lower than the Tₘ or T_{g}, strains are retained in the polymer, and the temporary shape change is maintained, even after the partial liberation of strain by the elasticity of the polymer.

The shaped article may be deformed in one, two or three dimensions. All or a portion of the shaped article may be deformed by mechanical deformation. The shaped article may be deformed by any desired method including embossing, compression, twisting, shearing, bending, cold molding, stamping, stretching, uniformly or non-uniformly stretching, or combinations thereof. Generally the double blind fastener is formed into a first substantially cylindrical shape and subsequently deformed by axial orientation (stretching). The axial orientation produce a longer and narrower cylinder from that first formed. This may be cut into preselected length suitable for forming a particular blind joint.

The original or permanent shape is recovered by heating the material above the Tₘ whereby the stresses and strains are relieved and the material returns to its original shape. The original or permanent shape of the shaped article can be recovered using a variety of energy sources. The composition can be immersed in a heated bath containing a suitable inert liquid (for example, water or a fluorochemical fluid) that will not dissolve or swell the composition in either its cool or warm states. The composition can also be softened using heat sources such as a hot air gun, hot plate, conventional oven, infrared heater, radiofrequency (R_{f}) sources or microwave sources. The composition can be encased in a plastic pouch, syringe or other container which is in turn heated (e.g. electrically), or subjected to one or more of the above-mentioned heating methods. Alternatively, the original shape of the deformed article may be recovered by exposure to a low molecular weight organic compound, such as a solvent, which acts as a plasticizer. The low molecular weight organic compound diffuses into the polymer bulk, triggering the recovery by disrupting the crystallinity of the crosslinked polycyclooctene.

In some embodiments, it may be desirable to recover only a portion of the shaped article. For example, heat and/or solvent can be applied to only a portion of the deformed surface of the substrate to trigger the shape memory recovery in these portions only.

In one embodiment, the shaped article may comprise a heating element, such as a resistive heating element encapsulated thereby. After deformation, the resistive heating element may be connected to a source of electricity imparting heat to the bulk of the polymer, which raises the temperature above the Tₘ so the deformed article assumes the original permanent shape.

In other embodiments, the heating step may be an indirect heating step whereby the deformed polymer is warmed by irradiation, such as infrared radiation. As the responsiveness of the shape memory polymer is limited by the heat capacity and thermal conductivity, the heat transfer can be enhanced by the addition of conductive fillers such as conductive ceramics, carbon black and carbon nanotubes. Such conductive fillers may be thermally conductive and/or electrically conductive. With electrically conductive fillers, the polymer may be heated by passing a current therethough. In some embodiments, the shape memory polymer may be compounded with conductive fillers, and the polymer heated inductively by placing it in an alternating magnetic field to induce a current.

The polymer compositions can be used to prepare articles of manufacture for use in biomedical applications. For example, sutures, orthodontic materials, bone screws, nails, plates, meshes, prosthetics, pumps, catheters, tubes, films, stents, orthopedic braces, splints, tape for preparing casts, and scaffolds for tissue engineering, implants, and thermal indicators, can be prepared.

The polymer compositions can be formed into the shape of an implant which can be implanted within the body to serve a mechanical function. Examples of such implants include rods, pins, screws, plates and anatomical shapes. A particularly preferred use of the compositions is to prepare sutures that have a rigid enough composition to provide for ease of insertion, but upon attaining body temperature, soften and form a second shape that is more comfortable for the patient while still allowing healing.

There are numerous applications for the shape memory polymer compositions other than biomedical applications. These applications include members requiring deformation restoration after impact absorption, such as bumpers and other auto body parts, packaging for foodstuffs, automatic chokes for internal combustion engines, polymer composites, textiles, pipe joints, heat shrinkable tubes, and clamping pins, temperature sensors, damping materials, sports protective equipment, toys, bonding materials for singular pipes internal laminating materials of pipes, lining materials, clamping pins, members requiring deformation restoration after impact absorption such as automobile bumpers and other parts.

In some embodiments, the shaped articles are fasteners, including grommets and rivets. A rivet may comprise a longitudinally-deformed shaped cylinder that may be inserted into an object or workpiece having an aperture therethrough. Upon heating, the deformed cylinder will contract longitudinally and expand laterally. The radii of the permanent and deformed shapes of the fastener are chosen such that the fastener may be inserted into the workpiece, but will expand to fill and grip the workpiece. Further, the degree of longitudinal deformation (stretching) of the fastener may be chosen such that the fastener will impart compression to the workpiece on heat recovery to the permanent shape.

### EXAMPLES

### Materials

Grubbs Second Generation catalyst was obtained from Sigma-Aldrich (St. Louis, Mo., USA). Dicyclopentadiene (DCPD) was obtained from Alfa Aesar (Ward Hill, Mass., USA). Toluene was obtained from Fisher Scientific (Pittsburgh, Pa., USA). Irganox™ 1010 (pentaerythrityl-tetrakis-3-(3′,5′-di-tert butyl-4-hydroxyphenyl)-propionate) and Irganox™ 1076 (octadecyl bis(3,5-t-butyl-4-hydroxyphenyl) propionate) were obtained from Ciba (Basel, Switzerland). Cyclooctene (COE) was obtained from Acros Organics (Geel, Belgium).

### Preparative Example 1

### COE-NB

This monomer was prepared using a procedure similarly described in patent GB 1312267 (1973). A mixture of 1,5-cyclooctadiene (201.2 g, 1.86 mol, Aldrich) and dicyclopentadiene (18.5 g, 0.14 mol, Aldrich) were placed in a 1 L stainless steel Parr vessel. The reactor was sealed and placed in an oven at 210° C. for 50 hours. The vessel was cooled, and the contents were distilled. Excess cyclooctadiene was removed at 35-40° C.@10 mmHg pressure. The remaining oil was distilled and a colorless fraction was collected at 60-75° C.@1 mmHg (26.373 g). This crude product was redistilled and a fraction was collected at 57-60° C.@1 mmHg (14.08 g).

### Preparative Example 2

### T-NB

Cyclopentadiene was obtained from dicyclopentadiene (Aldrich) by heating 140 g of dicyclopentadiene at 175° C. for 6 hours and collecting the distillate. 90 g of the freshly prepared cyclopentadiene was slowly added to a dried round bottom flask with 175 g of tricyclodecane dimethanol diacrylate (Aldrich). This solution was stirred at 55° C. for 20 hours, after which, excess cyclopentadiene was removed under vacuum (0.2 Torr for 4 hours). The resulting tricyclodecane dinorbornene (TCDDN) was used without further purification.

### Test Methods:

### DMA:

DMA experiments were performed in tensile mode on a TA Q800 Dynamic Mechanical Analyzer. Test samples were strips of material nominally 1 mm thick and 6 mm wide. The amplitude was maintained at 10 microns, the frequency was 1 Hz, and the ramp rate was 3° C./min.

### Shape Memory Polymer Characterization:

Shape-memory performance was evaluated through a tensile strain-recovery protocol. A strip of polymer was loaded into the tensile clamps of a TA Q800 DMA. The test strip was about 6.0 to 6.4 mm in width, 0.55 to 0.96 mm in thickness and about 20 mm in length. The material was then equilibrated at a temperature above the Tₘ (“Fixing Temperature”). A static force was applied to produce a strain in the range of 20%-100%. This static force was held constant as the material was then cooled to well below its Tₘ. The force was then relaxed and the temperature was ramped through the Tₘ while monitoring the strain recovery of the material. The recovered strain was defined as 1−(final strain−initial strain)/(peak strain−initial strain). The range of temperature over which the strain was recovered is characterized by the temperature at which the 20% of the strain recovery was complete and the temperature at which 80% of the strain recovery was complete. In some cases, the material was then immediately subjected to additional cycles of the strain-recovery testing. (In repeated cycles, the initial strain is defined as the final strain from the previous cycle.)

### Examples 1-5 and Comparative Examples 1-3

Grubbs II catalyst dissolved in toluene was added to the monomer solution containing cyclooctene and the multicyclic diene in the amounts shown in Table 1. Antioxidant, if used, was dissolved in the monomers. This mixture was then cast into a glass channel that was 1 mm deep, 25 mm wide, and between 30 and 40 mm long. The channel was then covered with glass. The samples were allowed to cure for 30 min at RT followed by 60 min at 100° C. Table 1 shows the formulations of crosslinked polymers that were prepared and tested.

| | | | Grubbs II | | Irganox | Irganox | E′ | E′ |
|---|---|---|---|---|---|---|---|---|
| | COE | Crosslinker | Catalyst | Toluene | 1076 | 1010 | @ 0° C. | @ 80° C. |
| Example # | (g) | (g) | (g) | (mL) | (g) | (g) | (MPa) | (MPa) |
| Comp. | 3 | none | 0.0003 | 0.005 | 0 | 0 | 480 | Yield |
| Ex. 1 | | | | | | | | |
| Comp. | 2.91 | none | 0.00017 | 0.05 | 0.090 | 0 | 160 | Yield |
| Ex. 2 | | | | | | | | |
| Comp. | 2.97 | none | 0.00017 | 0.015 | 0 | 0.03 | 204 | Yield |
| Ex. 3 | | | | | | | | |
| Comp. | 2.87 | DCPD | 0.002 | 0.05 | 0 | 0.03 | 6 | 0.3 |
| Ex 4 | | 0.09 | | | | | | |
| Comp. | 2.7 | COE-NB | 0.003 | 0.05 | 0 | 0 | 23 | 5 |
| Ex 5 | | 0.3 | | | | | | |
| Ex. 1 | 2.91 | COE-NB | 0.003 | 0.05 | 0 | 0 | 185 | 3.5 |
| | | 0.09 | | | | | | |
| Ex. 2 | 2.88 | COE-NB | 0.00017 | 0.05 | 0.09 | 0 | 130 | 3.7 |
| | | 0.03 | | | | | | |
| Ex. 3 | 2.94 | COE-NB | 0.00017 | 0.015 | 0 | 0.03 | 140 | 3.1 |
| | | 0.03 | | | | | | |
| Ex. 4 | 2.955 | T-NB | 0.00017 | 0.015 | 0 | 0.03 | 98 | 1.3 |
| | | 0.015 | | | | | | |
| Ex. 5 | 2.94 | DCPD | 0.00017 | 0.015 | 0 | 0.03 | 168 | 1.9 |
| | | 0.03 | | | | | | |

As can be seen in Table 1, with no additives, the modulus is relatively high at 0° C., (Comparative Ex. 1) but as either antioxidant (Comparative examples 2 and 3) or crosslinkers are added, the modulus at 0° C. drops. It is expected that additives should disrupt the ability of the polymer to crystallize.

The degree of crosslinking affects the modulus above the melting point (100° C.). With no crosslinking, the sample yields at high temperature and does not display shape-memory (comparative examples 1, 2, and 3).

The shape-memory characteristics of the crosslinked pCOE samples are shown in Table 2. The ratio of the peak stress and peak strain gives a general indication of the stiffness of the material above the melting point. A high stiffness in this rubbery region should correspond to high recovery force. A combination of high elongation and high stiffness should correspond to the greatest amount of potential energy available to do work during the recovery step of a shape-memory cycle.

TABLE 2

| | | | Peak | Peak | T Ramp | | T for 20% | T for 80% |
|---|---|---|---|---|---|---|---|---|
| | | Fixing T | Stress | Strain | Rate | % | Recovery | Recovery |
| Ex. # | Cycle | (° C.) | (MPa) | (%) | (° C./min) | Recovery | (° C.) | (° C.) |
| Ex. 1 | 1 | 100° C. | 0.4 | 21% | 2° C./min | 93% | 48.5° C. | 52.4° C. |
| Ex. 2 | 1 | 100° C. | 2.7 | 96% | 2° C./min | 90% | 51.5° C. | 56.9° C. |
| Ex. 3 | 1 | 70° C. | 3.3 | 105% | 2° C./min | 92% | 43.0° C. | 53.7° C. |
| | 2 | 70° C. | 3.6 | 114% | 2° C./min | 99% | 46.6° C. | 55.0° C. |
| | 3 | 70° C. | 3.7 | 117% | 2° C./min | 99% | 46.2° C. | 55.2° C. |
| Ex. 4 | 1 | 70° C. | 1.8 | 73% | 2° C./min | 94% | 50.3° C. | 54.7° C. |

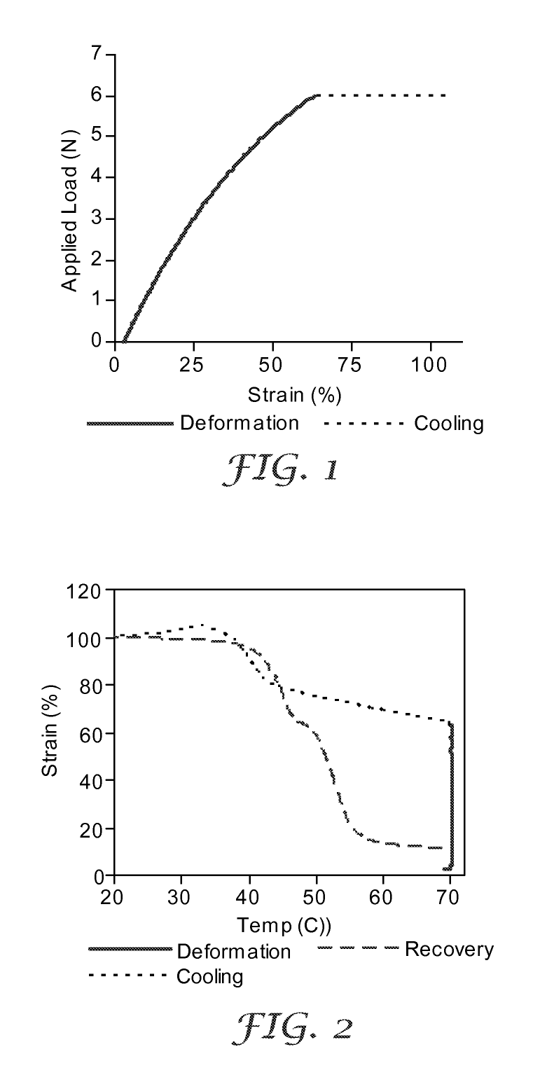

FIGS. 1 and 2 show a force-strain plot and a strain-temperature plot for the polymer of Example 3. FIG. 1 is a Force-Strain plot showing the initial deformation step followed by cooling while under constant applied load. FIG. 2 is a Strain-Temperature plot showing the initial deformation step above the melting temperature followed by cooling while under the static load, and then the recovery step of heating the sample with no applied load. The range of temperatures over which this strain is recovered remains fairly constant with the different formulations (46° C. to 57° C.).

What is claimed is:

1. A polymerizable composition comprising:
a) greater that 90 wt. % cyclooctene,
b) 0.1 to less than 10 wt. % of a multicyclic diene having at least two cyclo olefinic rings with at least two reactive double bonds;
c) less than 2 wt. % of a metathesis catalyst; and
d) optionally 5 wt. % or less of an antioxidant;
wherein said multicyclic diene is selected from the group consisting of: 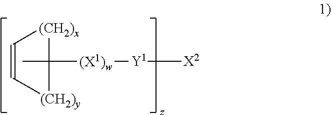
wherein X¹ is a divalent aliphatic group with 1 to 20 carbon atoms or an aromatic group;
w is 0 or 1;
X² is a polyvalent aliphatic group having 1 to 20 carbon atoms or an aromatic group;
Y¹ is a covalent bond or divalent functional group selected from the group consisting of esters, amides, ethers, urethanes and silanes;
x is at least one, y may be zero, and x+y is 6 to 20, and z is at least 2; or 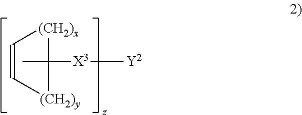
wherein
X³ is —O—, —S— or —NR¹—, where R¹ is H or C₁-C₄ alkyl,
Y² is a polyvalent aliphatic group having 1 to 20 carbon atoms or an aromatic group, optionally containing one or more Y¹ groups, where Y¹ is a divalent functional group selected from the group consisting of esters, amides, ethers, urethanes and silanes;
z is at least 2, x is at least one, y may be zero, and x+y is 6 to 20; or 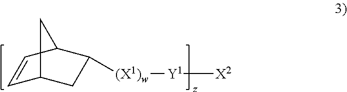
wherein
X² is a divalent aliphatic group having 1 to 20 carbon atoms or an aromatic group;
w is 0 or 1;
X² is a polyvalent aliphatic group having 1 to 20 carbon atoms or an aromatic group;
Y¹ is a covalent bond or divalent functional group selected from the group consisting of esters, amides, ethers, urethanes and silanes;
and z is at least 2; or 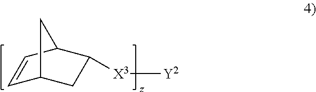
wherein
X³ is —O—, —S— or —NR¹—, where R¹ is H or C₁-C₄ alkyl,
Y² is a polyvalent aliphatic group having 1 to 20 carbon atoms or an aromatic group, optionally containing one or more Y¹ groups, where Y¹ is a covalent bond or divalent functional group selected from the group consisting of esters, amides, ethers, urethanes and silanes;
z is at least 2.

2. The polymerizable composition of claim 1 comprising greater than 95 wt. % of cyclooctene.

3. The polymerizable composition of claim 1 comprising greater than 97 wt. % of cyclooctene.

4. The polymerizable composition of claim 1 comprising 0.1 to 5 wt. % of an antioxidant.

5. The polymerizable composition of claim 1 comprising 0.5 to 3 wt. % of an antioxidant.

6. The polymerizable composition of claim 1 wherein the metathesis catalyst is a ruthenium carbene catalyst.

7. A crosslinked shape memory polymer comprising the reaction product of the composition of claim 1.

8. The crosslinked shape memory polymer of claim 7 having an elastic modulus of at least 90 MPa at 0° C. and an elastic modulus of at least 0.5 at 80° C.

9. A method for preparing a shaped article comprising the step of casting the composition of claim 1 into a mold and allowing it to cure.

10. The method of claim 9 further comprising the step of deforming the shaped article at a temperature below the Tₘ.

11. The method of claim 9 further comprising the step of deforming the article at a temperature above the Tₘ, then cooling the resulting deformed article below the Tₘ to maintain the shape of the deformed article.

12. The polymerizable composition of claim 1 comprising less than 3 wt. % of a multicyclic diene having at least two cyclo olefinic rings with at least two reactive double bonds.

13. The polymerizable composition of claim 1 wherein x+y is 6 to 10.

14. The polymerizable composition of claim 1 wherein said multicyclic diene is the Diels-Alder adduct of a diacrylate with cyclopentadiene.

15. The polymerizable composition of claim 1 wherein said multicyclic diene is the Diels-Alder adduct a cyclic diolefin and cyclopentadiene.

16. The polymerizable composition of claim 15 wherein said multicyclic diene is the Diels-Alder adduct of 1,5-cyclooctadiene and cyclopentadiene.
